(19) United States
(12) Patent Application Publication
(10) Pub. No.: US 2026/0077764 A1
(43) Pub. Date: Mar. 19, 2026

(54) METHOD OF A CONTROL SYSTEM FOR CONTROLLING A VEHICLE SPEED, A CONTROL SYSTEM, AND A VEHICLE COMPRISING THE CONTROL SYSTEM

(71) Applicant: Scania CV AB, Södertälje (SE)

(72) Inventors: Daniel Ståhl, Enköping (SE); Martin Berglund, Vagnhärad (SE); Jan Dellrud, Gnesta (SE); Frank Mohr, Värmdö (SE); Mikael Alenius, Segeltorp (SE); Henrik Sandstedt, Hägersten (SE)

(73) Assignee: Scania CV AB, Södertälje (SE)

(21) Appl. No.: 19/327,154

(22) Filed: Sep. 12, 2025

(30) Foreign Application Priority Data
Sep. 18, 2024 (SE) 2450918-4

(51) Int. Cl. B60W 30/14

(52) U.S. Cl. CPC B60W 30/143; B60W 2420/403; B60W 2420/408; B60W 2420/54; B60W 2520/10; B60W 2530/201; B60W 2552/35; B60W 2554/20; B60W 2554/4029; B60W 2554/4044; B60W 2556/40; B60W 2556/45

(57) ABSTRACT

A method of a control system for controlling a vehicle speed v of a vehicle is presented. The method comprises: controlling the vehicle speed v towards an adjusted reference speed v_{ref_adj} based on: a reference speed v_{ref} provided by a speed control system of the vehicle; a usable road width Wᵤᵣ of a road section ahead of the vehicle; and an effective vehicle width Wₑᵥ of the vehicle. Hereby, the safety and comfort of the driver is improved.

### TECHNICAL FIELD

The present invention relates to vehicle speed control and more specifically to a method for controlling a vehicle speed in a narrow or curved road section, to a control system configured for performing the speed control, and to a vehicle comprising the control system. The present invention also relates to a computer program and a computer-readable medium executing the method.

### BACKGROUND

The following background description constitutes a description of the background to the present invention, which does not, however, necessarily have to constitute prior art.

Vehicles of today are often equipped with a speed/cruise control system, which is configured to control the speed of the vehicle. The driver of the vehicle choses a set speed, and the speed/cruise control system then controls the vehicle speed based on this set speed, and possibly also based on other parameters, such that a good fuel or energy economy, i.e. a low fuel or energy consumption, is provided for the vehicle.

There are today many types of speed/cruise control systems, in which various kinds of information/parameters are utilized as a basis for the control of the vehicle speed. Generally, the speed/cruise control systems of today are designed to provide a more fuel or energy efficient vehicle speed control than a driver would be able to provide by manually controlling the speed of the vehicle. The modern speed/cruise control systems may for example have access to additional information which is unknown to the driver, such as slope/inclination angles and/or information related to parameters not being visible for the driver, e.g. road properties behind crests or curves. Such additional information may be utilized for more efficiently controlling the vehicle speed.

### BRIEF DESCRIPTION OF THE INVENTION

When driving in road sections with restricted road width or curves with an activated speed/cruise control system, the resulting vehicle speed being the result of the speed/cruise control function may be too high for the driver to be safe and/or feel comfortable.

For example, if there is oncoming traffic, stationary vehicles, bicycles or persons in the road section, which may be straight or curved, the vehicle speed being provided by the speed/cruise control system might be too high to be safe and/or might feel too high for the driver of the vehicle. Thus, the regulated vehicle speed might be too high to provide enough safety margins and/or the driver may be uncomfortable at the regulated vehicle speed. If the driver is uncomfortable at the regulated vehicle speed, a natural reaction would be to deactivate the speed/cruise control function, e.g. by braking the vehicle or by actively turning the speed/cruise control function off.

If the speed/cruise control function is deactivated, the fuel or energy consumption generally increases, since it is difficult for a driver to manually control the vehicle speed as efficiently as the speed/cruise control systems of today can control it. Also, by actively and unnecessary braking the vehicle, kinetic energy is almost always wasted.

It is therefore an objective of the present invention to provide a vehicle speed control such that these problems are at least partly solved.

According to a first aspect of the present invention, the objective is achieved through a method of a control system for controlling a vehicle speed v of a vehicle.

The method comprises:
controlling the vehicle speed v towards an adjusted reference speed v_{ref_adj} based on:
a reference speed v_{ref} provided by a speed control system of the vehicle;
a usable road width Wᵤᵣ of a road section ahead of the vehicle; and
an effective vehicle width Wₑᵥ of the vehicle.

By taking the usable road width Wᵤᵣ of a road section ahead of the vehicle and the effective vehicle width Wₑᵥ of the vehicle into consideration when determining the adjusted reference speed v_{ref_adj}, towards which the vehicle speed v is controlled, possibly dangerous road restrictions, curves and/or oncoming traffic are taken into account by the presented method. Also, a possible discomfort experienced by the driver in the road section is taken into consideration.

For example, if there is oncoming traffic in a straight or curved narrow road section, this may lead to a dangerous situation if the two vehicles meet in full speed in the narrow road section. Also, the driver may feel that the vehicle speed v normally controlled by the speed control system is too high, which may cause discomfort or even anxiety for the driver of the vehicle. There is therefore a risk that the driver manually deactivates the speed control function/system due to the experienced discomfort. As mentioned above, a manually controlled vehicle speed often results in an increased fuel or energy consumption, since it is almost impossible for a driver to manually regulate the vehicle speed as efficiently as modern speed control systems do. Also, if the driver actively brakes the vehicle kinetic energy is wasted by the braking.

Thus, the herein presented vehicle speed v control, which also takes the usable road width Wᵤᵣ of a road section ahead of the vehicle and the effective vehicle width Wₑᵥ of the vehicle into account, reduces the risk for accidents and also reduces the risk for deactivation of the speed control function/system.

Also, if there is road section is not narrow or curved, and if there is no oncoming traffic, the vehicle speed v may be kept high, such that the driver does not deactivate the speed control function/system by pressing the accelerator pedal of the vehicle.

Hereby, an overall reduced, or at least non-increased, fuel or energy consumption is provided.

According to an embodiment, the method further comprises:
receiving the reference speed v_{ref} from the speed control system; and
determining the adjusted reference speed v_{ref_adj} based on:
the received reference speed v_{ref};
the usable road width Wᵤᵣ of the road section ahead of the vehicle; and
the effective vehicle width Wₑᵥ of the vehicle.

Hereby, the usable road width Wᵤᵣ of a road section ahead of the vehicle and the effective vehicle width Wₑᵥ of the vehicle are efficiently taken into consideration when determining the adjusted reference speed v_{ref_adj}, towards which the vehicle speed v is controlled. To adjust the reference speed v_{ref} provided by the speed control system like this is a low complex approach to improve the safety and also the comfort of the driver when travelling through restricted and/or curved road sections.

According to an embodiment, the adjusted reference speed v_{ref_adj} is determined such that the vehicle is prevented from entering into the road section when a difference D between the usable road width Wᵤᵣ and the effective vehicle width Wₑᵥ; D=Wᵤᵣ−Wₑᵥ; is less than a first difference threshold D_{th_1}; D<D_{th_1}.

Hereby, the vehicle speed v is controlled to be reduced, or increased, such that for example a narrow road section is passed after, or before, an oncoming vehicle passes the narrow road section. This increases the safety margins and also helps the driver to feel safe and comfortable, since the vehicle speed is controlled in a way similar to how the driver would manually control the speed. The driver will therefore continue to let the speed control function/system control the vehicle speed.

Also, the driver may be helped to control the vehicle speed based on information unknown by the driver in a situation. For example, the control system for controlling the vehicle speed may know that there is an oncoming vehicle approaching a curve ahead before the oncoming vehicle is visible for the driver. The vehicle speed may then be controlled to be reduced, whereby the safety margins are increased by a speed control that would not be possible for the driver to perform.

According to an embodiment, the first difference threshold D_{th_1} is one in the group of:
a value associated with one or more of a current vehicle speed v_{cur}, a visibility of the road section, and a risk for injuries in the road section;
a value less than or equal to 20% of the usable road width Wᵤᵣ; D_{th_1}≤0.2*Wᵤᵣ; and
a value less than or equal to zero; D_{th_1}≤0.

By a suitable choice of the first difference threshold D_{th_1} like this, increased safety and driver comfort are provided.

According to an embodiment, the adjusted reference speed v_{ref_adj} is determined to be reduced below the reference speed v_{ref} if the vehicle will enter into the road section when a difference D between the usable road width Wᵤᵣ and the effective vehicle width Wₑᵥ; D=Wᵤᵣ−Wₑᵥ; is less than a second difference threshold D_{th_2}; D<D_{th_2}.

Thus, if the vehicle is entering into a road section although it is narrow or curved, e.g. if the entering of the road section is inevitable and cannot be prevented, the vehicle speed v is controlled to be reduced. This helps the driver to feel safe and comfortable, since the vehicle speed is controlled in a way similar to how the driver would manually control the speed. The driver will therefore continue to let the speed control function/system control the vehicle speed.

According to an embodiment, the second difference threshold D_{th_2} is one in the group of:
a value associated with one or more of; a current vehicle speed v_{cur}, a visibility of the road section, and a risk for injuries in the road section; and
a value less than 50% of the usable road width Wᵤᵣ; D_{th_2}<0.5*Wᵤᵣ.

By a suitable choice of the second difference threshold D_{th_2} like this, increased safety and driver comfort are provided.

According to an embodiment, the speed control system is one in the group of:
a cruise control system;
an adaptive cruise control system; and
an active prediction cruise control system;
a curve speed cruise control system;
a one pedal drive system;
an adaptive one pedal drive system;
a cruise control system obtaining a speed demand from an offboard entity; and
a cruise control system utilizing traffic sign recognition.

Thus, the herein presented control of the vehicle speed may be combined with essentially any existing speed control system today, resulting in a flexible implementation.

According to an embodiment, the method comprises:
determining the usable road width Wᵤᵣ based on information provided by one or more onboard sensors of the vehicle.

Information provided by one or more onboard sensors is always available in the vehicle, also if there is no communication system coverage at the position where the vehicle is travelling, such as e.g. at the countryside, in remote woods or in tunnels.

According to an embodiment, the one or more onboard sensors comprise at least

one in the group of:
a camera;
a radar system;
a sonar system; and
a lidar system; and
a road sensor.

Thus, the herein presented control of the vehicle speed may be performed based on information provided by a large number of onboard sensors, and may therefore be implemented in essentially any vehicle of today.

According to an embodiment, the method comprises:
determining the usable road width Wᵤᵣ based on map data.

Detailed map data is today available for large parts of the road network. The map data is very accurate and may be periodically updated such that it is up to date. Together with positioning information, such as e.g. global positioning system (GPS) information, for example characteristics of road width, curves, buildings and obstacles in the road section may be accurately and efficiently detected/determined.

According to an embodiment, the method comprises:
determining the usable road width Wᵤᵣ based on vehicle-to-everything information provided to the control system.

By utilizing vehicle-to-everything information, determinations and/or observations made by e.g. other vehicles and/or systems may be taken advantage of. For example, if a usable road width Wᵤᵣ has already been determined by another vehicle having travelled through the road section at an earlier time instant, this determined usable road width Wᵤᵣ may be transmitted to, and utilized by, the vehicle when it subsequently travels through that road section.

According to an embodiment, the usable road width Wᵤᵣ comprises a drivable road width W_{dr} of the road section minus an unusable road width Wuu of the road section; Wᵤᵣ=W_{dr}−Wᵤᵤ.

Hereby, the control of the vehicle speed v is performed based on information usually being used as a basis for driving decisions made by a driver of the vehicle when manually controlling the vehicle speed. The driver therefore understands and feels comfort in the resulting vehicle speed control.

According to an embodiment, the unusable road width Wᵤᵤ is occupied by one or more in the group of:
at least one other oncoming vehicle traveling in the road section in a direction opposite to the vehicle;
a safety area around at least one other oncoming vehicle traveling in the road section in a direction opposite to the vehicle;
at least one other vehicle traveling in the road section in a same direction as the vehicle and at a different speed vₒ than the vehicle speed v of the vehicle; vₒ≠v;
a safety area around at least one other vehicle traveling in the road section in a same direction as the vehicle and at a different speed vₒ than the vehicle speed v of the vehicle; vₒ≠v;
at least one stationary vehicle on the road in the road section;
at least one obstacle on the road in the road section;
at least one hole on the road in the road section (620);
at least one person on the road in the road section;
at least one object on the road in the road section;
a safety zone around at least one stationary vehicle adjacent to the road in the road section;
a safety zone around at least one obstacle adjacent to the road in the road section;
a safety zone around at least one person adjacent to the road in the road section; and
a safety zone around at least one object adjacent to the road in the road section.

Hereby, the control of the vehicle speed v is performed based on information usually being used as a basis for driving decisions made by a driver of the vehicle, e.g. is based on what the driver sees in front of the vehicle. The provided vehicle speed control therefore resembles a manual control of the vehicle speed performed by the driver. The driver therefore understands and feels comfort in the provided vehicle speed control. The risk for deactivation of the vehicle speed control is therefore very low.

According to an embodiment, wherein the road section comprises at least one curve, and the method comprises:
determining the effective vehicle width Wₑᵥ of the vehicle for the at least one curve based on a road area swept by the vehicle in the at least one curve, wherein the effective vehicle width Wₑᵥ of the vehicle for the at least one curve exceeds a physical width W_{phy} of the vehicle; Wₑᵥ>W_{phy}.

Hereby, it is taken into consideration that a long vehicle sweeps a considerable road area e.g. in tight curves, which may cause danger and/or driver discomfort in narrow road sections, e.g. when meeting oncoming traffic. The vehicle speed may then be reduced to resemble a manual control of the vehicle speed performed by the driver.

According to an embodiment, wherein the road section comprises at least one straight road stretch, and the method comprises:
determining the effective vehicle width Wₑᵥ of the vehicle for the at least one straight road stretch to be equal to a physical width W_{phy} of the vehicle; Wₑᵥ=W_{phy}.

Hereby, the vehicle speed may be kept higher in straight road sections than in curved road sections, which is similar to how the driver would control the vehicle. The risk for deactivation of the vehicle speed control is therefore reduced.

According to a second aspect of the present invention, the objective is achieved through a control system configured to control a vehicle speed v of a vehicle, wherein the control system is configured to:
control the vehicle speed v towards an adjusted reference speed v_{ref_adj} based on:
a reference speed v_{ref} provided by a speed control system of the vehicle;
a usable road width Wᵤᵣ of a road section ahead of the vehicle; and
an effective vehicle width Wₑᵥ of the vehicle.

The control system has corresponding advantages as mentioned for the method according to the first aspect.

According to a third aspect of the present invention, the objective is achieved through a vehicle comprising a herein described control system.

The vehicle has corresponding advantages as mentioned for the method according to the first aspect.

According to a fourth aspect, the invention relates to a computer program comprising instructions which, when the program is executed by a computer, cause the computer to carry out the herein described methods.

The computer program has corresponding advantages as mentioned for the method according to the first aspect.

According to a fifth eleventh, the invention relates to a computer-readable medium comprising instructions which, when executed by a computer, cause the computer to carry out the herein described methods.

The computer-readable medium has corresponding advantages as mentioned for the method according to the first aspect.

It will be appreciated that all the embodiments described for the method aspects of the invention are applicable also to one or more of the control system aspect, the vehicle aspect, the computer program aspect and the computer-readable medium aspect of the invention. Thus, all the embodiments described for the method aspects of the invention may be performed/implemented by the herein described control system, vehicle, computer program and/or the computer-readable medium. The control system may also be a processing device, i.e. a device. The control system aspect, the vehicle aspect, the computer program aspect and the computer-readable medium aspect, and their embodiments, have advantages corresponding to the advantages mentioned above for the methods and their embodiments.

### BRIEF LIST OF FIGURES

Embodiments of the invention will be illustrated in more detail below, along with the enclosed drawings, where similar references are used for similar parts, and where:

FIG. 1 schematically illustrates an example vehicle, in which aspects and/or embodiments of the present invention may be implemented,

FIG. 2 shows a flow chart diagram for a method of a control system for controlling a vehicle speed v of a vehicle according to some aspects and/or embodiments of the present the invention,

FIG. 3 schematically illustrates a non-limiting driving example for which herein presented aspects and/or embodiments of the present the invention may be utilized,

FIGS. 4a-c schematically illustrates a non-limiting example of some herein presented embodiments,

FIGS. 5a-c schematically illustrates a non-limiting example of some herein presented embodiments,

FIG. 6 schematically illustrates a non-limiting driving example for which herein presented aspects and/or embodiments of the present the invention may be utilized,

FIG. 7 shows a flow chart diagram for a method for controlling a vehicle speed v of a vehicle according to some embodiments of the present the invention, and

FIG. 8 schematically illustrates a control unit according to various embodiments of the present invention.

### DESCRIPTION OF PREFERRED EMBODIMENTS

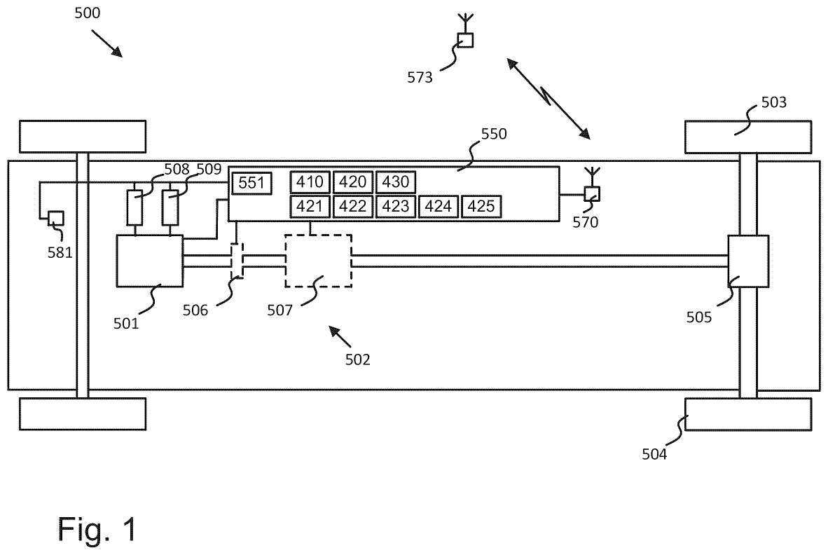

FIG. 1 schematically shows an exemplary heavy vehicle 500. This example vehicle 500 will be used to explain the herein presented solution and its aspects and embodiments. The aspects and embodiments are, however, not limited to use in vehicles as the ones shown in FIG. 1, but may also be used in essentially any other type of vehicle.

The vehicle 500 comprises multiple wheels, of which at least one pair of drive wheels 503, 504. The truck 500 furthermore comprises at least one powertrain 502 configured to transfer a torque between at least one power source 501, such as e.g. a combustion engine, at least one electric machine, or a combination of a combustion engine and at least one electric machine, implementing a so-called hybrid drive, to the at least one pair of drive wheels 503, 504. The combustion engine is provided with fuel from a fuel tank 508. The at least one electric machine is provided with electrical energy from at least one voltage energy storage 509, e.g. a battery pack, coupled to the at least one electric machine.

The powertrain 502, and its components, is controlled by at least one control unit/device/system 550. The at least one second energy storage 509 may also be controlled by a control unit/device/system 550.

The torque provided by the at least one power source 501 may be provided to the at least one pair of drive wheels 503, 504 via a central gear 505, such as e.g. a customary differential, and drive shafts connected with the central gear. One or more electric machines may also be arranged essentially anywhere in the vehicle 500, as long as the produced torque is provided to the drive wheels 503, 504, e.g. adjacent to one or more of the drive wheels 503, 504, as is understood by a skilled person.

The vehicle 500 may be braked by utilizing the at least one power source 501, i.e. by utilizing regenerative braking or motor braking. The vehicle 500 may further include at least one braking arrangement arranged at each one of the wheels of the vehicle, where the at least one braking arrangement may be included in a braking system. If the at least one power source 501 comprises a combustion engine, the powertrain 502 of the vehicle 500 may comprise a clutch 506 and a gearbox 507 for providing the torque to the central gear 505. However, if the at least one power source 501 does not comprise a combustion engine, the clutch 506, and possibly also the gearbox 507, may be omitted in the powertrain 502 of the vehicle 500.

The power source 501, is controlled by a speed/cruise control system 551, which may be comprised/implemented in the control unit/device/system 550 of the vehicle 500, such that the vehicle speed v of the vehicle 500 is controlled.

In FIG. 1, only the units/devices/entities of the vehicle being useful for understanding the present invention are schematically illustrated. Not all illustrated components have to be comprised in the vehicle, depending on the implementation of the present invention. Further, the control unit/device/system 550 is in FIG. 1 illustrated as one single unit/device/system. However, as is understood by a skilled person, the control unit/device/system 550 may be implemented by utilization of essentially any number of units/devices/systems.

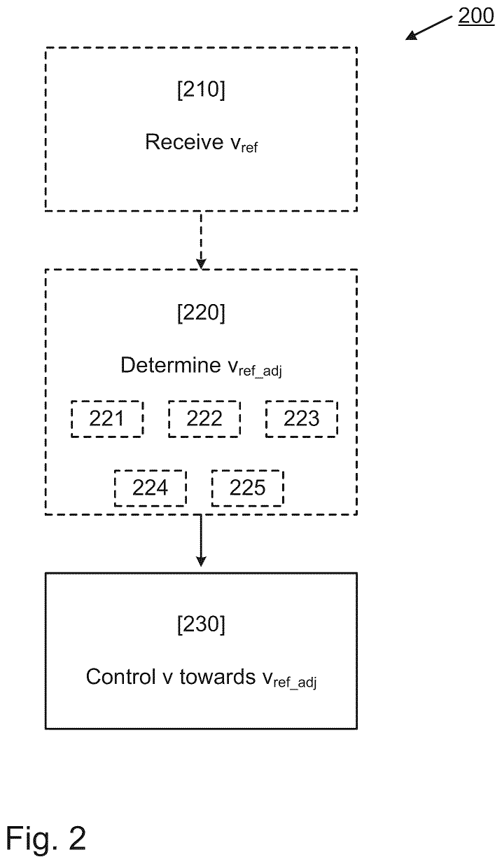

FIG. 2 shows a flow chart diagram for a method 200 for controlling a vehicle speed v of a vehicle 500 according to some aspects and/or embodiments.

The method 200 comprises the step 230 of controlling the vehicle speed v towards an adjusted reference speed v_{ref_adj} based on a reference speed v_{ref} provided by a speed control system 551 of the vehicle 500, a usable road width Wᵤᵣ of a road section 620 ahead of the vehicle 500, and an effective vehicle width Wₑᵥ of the vehicle 500.

According to an embodiment, method 200 further comprises the step 210 of receiving the reference speed v_{ref} from the speed control system 551 of the vehicle 500. The method then comprises the further step 220 of determining the adjusted reference speed v_{ref_adj} based on the received reference speed v_{ref}, the usable road width Wᵤᵣ of the road section 620 ahead of the vehicle 500 and the effective vehicle width Wₑᵥ of the vehicle 500.

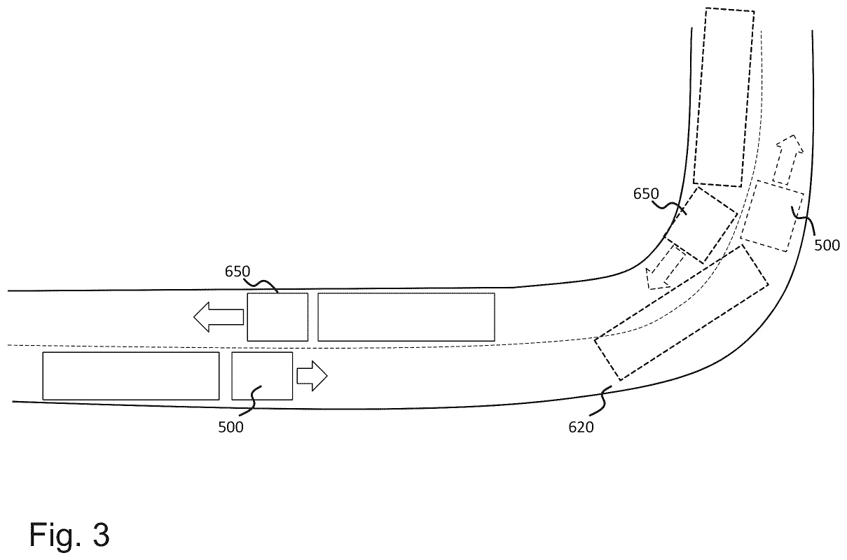

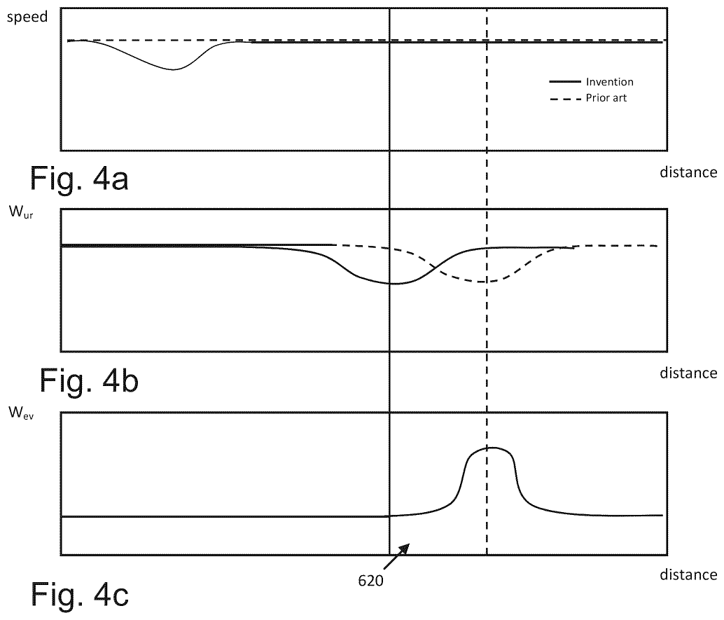

FIGS. 3 and 4a-c schematically illustrate an embodiment, according to which the adjusted reference speed v_{ref_adj} is determined 220 such that the vehicle 500 is prevented from entering into the road section 620 when a difference D between the usable road width Wᵤᵣ and the effective vehicle width Wₑᵥ; D=Wᵤᵣ−Wₑᵥ; is less than a first difference threshold D_{th_1}; D<D_{th_1}. For example, if the road section 620 ahead of the vehicle is narrow in relation to effective vehicle width Wₑᵥ, e.g. due to that an oncoming vehicle will meet the vehicle 500 in a width restricted road or a tight curve, then the adjusted reference speed v_{ref_adj} is determined 220 such that the vehicle speed v 500 is reduced or increased in a way that the vehicle does not enter into the road section 620 as long as the oncoming vehicle is in the road section 620, i.e. to avoid D<D_{th_1}. This may for example mean that the vehicle is slowed down, thereby letting an oncoming vehicle pass through the narrow road section 620 before the vehicle 500 enters into the road section 620.

According to an embodiment, the first difference threshold D_{th_1} may be a value associated with a current vehicle speed v_{cur}, a visibility of the road section 620, and a risk for injuries in the road section 620. The current vehicle speed v_{cur} may, according to an embodiment, be related to a speed of an oncoming vehicle, such that the first difference threshold D_{th_1} is assigned a lower value for higher speeds of the oncoming vehicle, thereby further reducing the vehicle speed v of the vehicle 500 when meeting faster oncoming vehicles. The first difference threshold D_{th_1} may also be a value less than or equal to 20% of the usable road width Wᵤᵣ; D_{th_1}≤0.2*Wᵤᵣ, or a value less than or equal to zero; D_{th_1}≤0. Thus, for very narrow road sections in relation to the effective vehicle width Wₑᵥ, the adjusted reference speed v_{ref_adj} is determined 220 such that the vehicle 500 is prevented from entering into the road section 620.

FIGS. 3 and 4a-c schematically illustrate a non-limiting example of a driving situation in which the vehicle 500 is slowed down in order to let an oncoming vehicle 650 pass through a curved road section 620, before the vehicle 500 enters into the curved road section 620.

FIG. 3 shows the vehicle 500 driving on a road with a curved road section 620 and an oncoming vehicle 650 driving in the opposite direction. The dashed vehicle 500 and the dashed oncoming vehicle 650 illustrates a situation which could occur if the vehicle speed v would be controlled by conventional speed control systems, where the vehicle 500 meets the oncoming vehicle 650 in the worst possible position, i.e. in the curve of the road section 620. The driver may here have to use the brakes to brake the vehicle to avoid this, which causes energy wasting. Also, such a difficult traffic situation may cause danger and/or driver discomfort. The confidence of the driver in the speed control system may hereby also be reduced, leading to possible deactivation or overriding of the speed control system, and therefore also to increased overall energy consumption.

In FIGS. 4a-c, the dashed lines illustrate parameters of conventional solutions, and the solid lines illustrate parameters of the herein presented aspects and embodiments.

FIG. 4a illustrates a dashed conventional vehicle speed resulting from a conventional speed control system, i.e. corresponding to a reference speed v_{ref} from the speed control system 551, and a solid vehicle speed v resulting from a herein presented aspect or embodiment, i.e. corresponding to the herein presented adjusted reference speed v_{ref_adj}.

FIG. 4b illustrates a dashed line conventional usable road width Wᵤᵣ for a conventional speed control system and solid line usable road width Wᵤᵣ for a herein presented aspect or embodiment.

FIG. 4c illustrates a dashed line conventional effective vehicle width Wₑᵥ for a conventional speed control system and solid line effective vehicle width Wₑᵥ for a herein presented aspect or embodiment, which coincide.

The dashed conventional solution lines in FIGS. 4a-c show the dashed line example in FIG. 3, i.e. an example of the vehicle 500 meeting the oncoming vehicle 650 in the curved road section 620. For a conventional speed control system, the resulting vehicle speed is controlled to be constant (FIG. 4a). This causes the minimum value for the usable road width Wᵤᵣ (FIG. 4b) to coincide with the maximum value of the effective vehicle width Wₑᵥ for the vehicle 500 (FIG. 4c) at the dashed vertical line. This means that the vehicle 500 meets the oncoming vehicle 650, which reduces the drivable road width W_{dr}, by sweeping a road area in the curve, where its own effective vehicle width Wₑᵥ is considerably increased due to the road area being swept by the vehicle 500 itself in the curve.

The solid lines in FIGS. 4a-c, illustrating a herein presented aspect or embodiment, however, show a reduction in vehicle speed v before the curved road section 620 (FIG. 4a). Hereby, the minimum value for the usable road width Wᵤᵣ, i.e. the maximum swept road area of the meeting oncoming vehicle 650 in the curve, is moved to a shorter travelled distance, i.e. is moved to before the curve-taking of the vehicle 500 (FIG. 4b). This also means that the vehicle 500 and the oncoming vehicle 650 meet before the effective vehicle width Wₑᵥ for the vehicle 500 increases due to the road area being swept by the vehicle 500 in the curve (FIG. 4c). Thus, according to the herein presented vehicle speed control, the solid vertical line indicating the minimum value for the usable road width Wᵤᵣ is moved away from the maximum value of the effective vehicle width Wₑᵥ for the vehicle 500. As schematically illustrated in solid lines in FIG. 3, the herein presented vehicle speed control results in that the vehicle 500 and the oncoming vehicle 650 meet before the curve.

According to another embodiment, the vehicle speed v may be increased before the curve, i.e. instead of being reduced as illustrated in FIG. 4a. Hereby, the vehicle 500 and the oncoming vehicle 650 would meet after the curve illustrated in FIG. 3.

Although FIG. 3 illustrates a driving example with an oncoming vehicle 650, corresponding vehicle speed control may be utilized in other situations, such as for overtaking a bicyclist/bicycle in a curve, or for meeting oncoming traffic when overtaking a bicyclist/bicycle. Also, corresponding control may be applied to a narrow road section 620 as to a curved road section.

According to an embodiment, the adjusted reference speed v_{ref_adj} is determined 220 to be reduced below the reference speed v_{ref} from the speed control system 551 if the vehicle 500 will enter into the road section 620 when a difference D between the usable road width Wᵤᵣ and the effective vehicle width Wₑᵥ; D=Wᵤᵣ−Wₑᵥ; is less than a second difference threshold D_{th_2}; D<D_{th_2}. Thus, if the vehicle 500 will proceed and enter into the narrow road section 620, the adjusted reference speed v_{ref_adj} is decreased such that the vehicle speed v is reduced before entering and/or during the road section 620.

According to an embodiment, the second difference threshold D_{th_2} is a value associated with a current vehicle speed v_{cur}, a visibility of the road section 620 and or a risk for injuries in the road section 620. The second difference threshold D_{th_2} may, according to an embodiment, further be associated with a load of the vehicle and/or with a length of the vehicle. The second difference threshold D_{th_2} may, according to an embodiment, be adjusted based on a previous driver action in a similar situation, e.g. if the driver has previously pressed down the accelerator pedal when the vehicle speed v has been reduced in such a narrow road section 620. According to an embodiment, the second difference threshold D_{th_2} is a value less than 50% of the usable road width Wᵤᵣ; D_{th_2}<0.5*Wᵤᵣ.

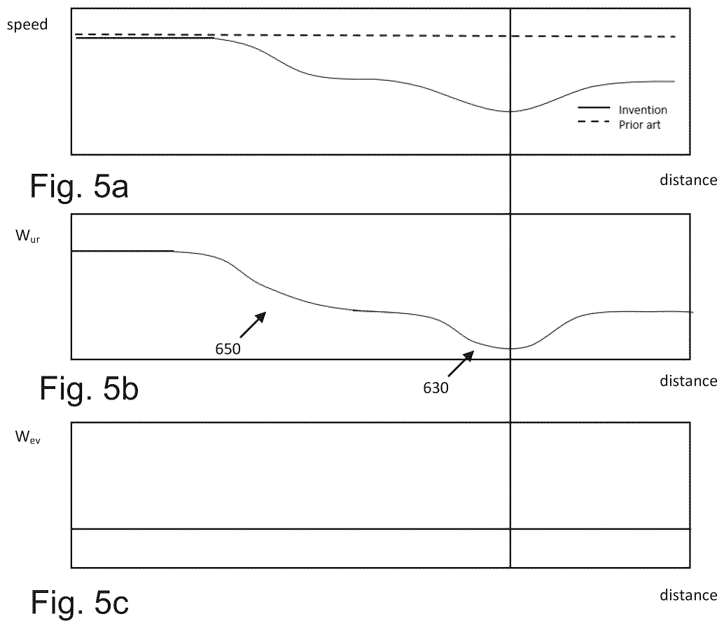

FIGS. 5a-c and 6 schematically illustrate a non-limiting example of a driving situation in which the vehicle 500 is slowed down in order to decrease a possible discomfort of a driver when meeting an oncoming vehicle 650 in a straight narrow road section 620 is inevitable.

In FIG. 5a, the dashed line illustrates conventional speed control, and the solid line illustrates a herein presented aspect or embodiment.

FIG. 5a illustrates a dashed line conventional vehicle speed resulting from a conventional speed control system, i.e. corresponding to a reference speed v_{ref} from the speed control system 551, and a solid line vehicle speed v resulting from a herein presented aspect or embodiment, i.e. corresponding to the herein presented adjusted reference speed v_{ref_adj}.

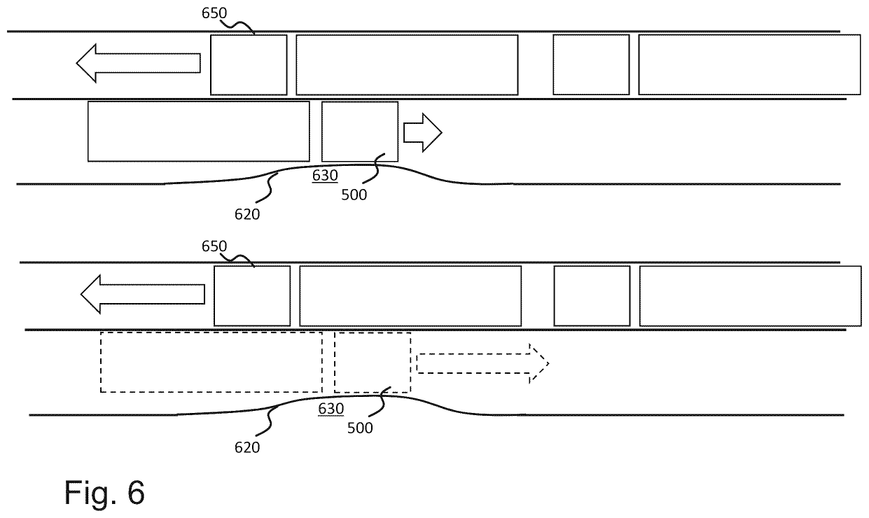

FIG. 5b illustrates a usable road width Wᵤᵣ for the straight road in the example shown in FIG. 6. The usable road width Wᵤᵣ is first reduced by the oncoming traffic/vehicle 650 and is then further reduced due to the obstacle 630 causing a portion of the road section 620 to be narrower.

FIG. 5c illustrates an effective vehicle width Wₑᵥ for the vehicle 500 for the road section 620 shown in FIG. 6. Since the road section 620 is straight, the effective vehicle width Wₑᵥ is constant.

The dashed conventional solution line in FIG. 5a shows the vehicle speed for the dashed line example in FIG. 6, i.e. an example of the vehicle 500 meeting an oncoming vehicle 650 in the straight narrow road section 620, e.g. being obstructed by an obstacle 630 of some kind. For a conventional speed control system, the resulting vehicle speed is controlled to be constant, as shown in FIG. 5a. This means that the vehicle 500 would conventionally meet the oncoming vehicle 650, which further reduces the usable road width Wᵤᵣ, in the already narrow road section 620 at the same speed as if the vehicle 500 would travel on a wide road without traffic, as illustrated in dashed lines in FIGS. 5a and 6. The driver may here have to use the brakes to brake the vehicle to avoid this high speed meeting with the oncoming vehicle 650, which causes energy wasting. Also, such a traffic situation may cause danger and/or driver discomfort. The confidence of the driver in the speed control system may also be reduced, leading to deactivation or overriding of the speed control system, and therefore also to increased energy consumption.

The solid line in FIG. 5a, illustrating a herein presented aspect or embodiment, however, shows a reduction in vehicle speed v due to the oncoming vehicle 650. Hereby, the safety margins are increased when meeting the oncoming traffic 650. Also, the vehicle speed v is further reduced when the vehicle enters into the narrow portion of the road section 620, caused by the obstacle 630, as illustrated in solid lines in FIGS. 5a, 5b and 6. Thus, in this example, the vehicle speed v is further reduced when the usable road width Wᵤᵣ is reduced by both obstacles 630 on the road and by other vehicles 650 at the vertical solid line in FIGS. 5a and 5b.

As schematically illustrated in solid lines in FIGS. 5a and 6, the herein presented vehicle speed control results in that the vehicle 500 has a lower vehicle speed v when the vehicle 500 and the oncoming vehicle 650 meet in the narrow portion. Thus, if it is inevitable that the vehicle 500 will meet the oncoming traffic 650 in the narrow portion, then the vehicle speed v is considerably reduced such that the situation is neither dangerous nor unpleasant for the driver of the vehicle 500.

It may be noted, that although FIG. 6 illustrates a driving example with an oncoming vehicle 650 in a straight narrow road section 620, a corresponding vehicle speed control may be utilized in other situations, such as for curved road sections, or narrow and curved road sections. Corresponding vehicle speed control may also be utilized when overtaking a bicyclist/bicycle in a narrow and/or curved road section, when overtaking a bicyclist/bicycle at oncoming traffic, or when overtaking a bicyclist/bicycle in a narrow and/or curved road sections with weak road edges.

As a non-limiting example, if the narrow road section 620 would also be curved, the effective vehicle width Wₑᵥ for the vehicle 500 shown in FIG. 5c would have an increase in the curve due to the swept road area in the curve. According to an embodiment of the herein presented vehicle speed control, the vehicle speed v would in such a situation, i.e. when the vehicle 500 meets oncoming traffic in a narrow and curved road section, be even further reduced than shown in FIG. 5a. Hereby, the safety margins and the driver comfort are further improved.

For a conventional speed control system, however, the resulting vehicle speed would be controlled to be constant, as shown by the dashed line in FIG. 5a, also when meeting the oncoming vehicle in a curved and narrow road section. Thus, the vehicle 500 would conventionally also meet the oncoming vehicle 650, which further reduces the usable road width Wᵤᵣ, in a curved and narrow road section at the same speed as if the vehicle 500 would travel on a wide and straight road without traffic. The conventional speed control would hereby at least cause driver discomfort, and possibly also dangerous situations.

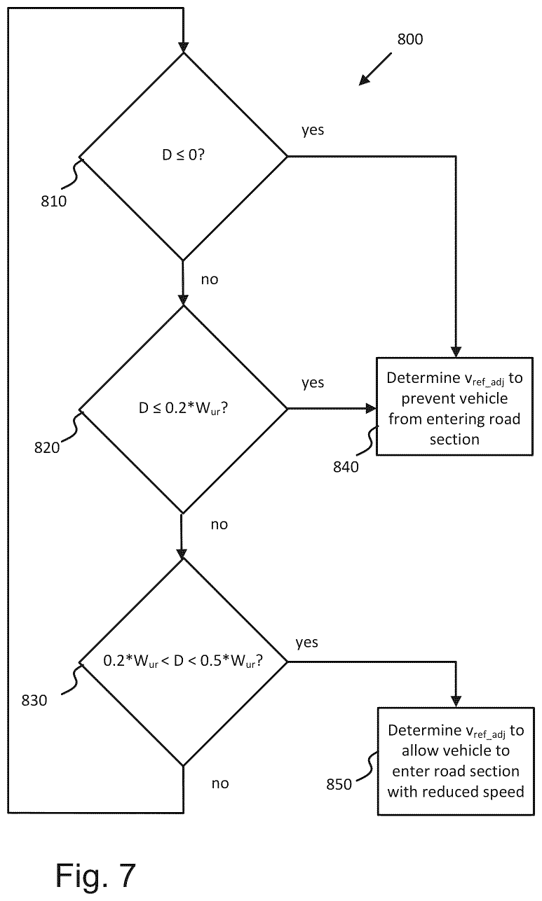

FIG. 7 shows a flow chart diagram illustrating a method 800 according to an embodiment determining how the adjusted reference speed v_{ref_adj} is determined for various values of the difference D between the usable road width Wᵤᵣ and the effective vehicle width Wₑᵥ; D=Wᵤᵣ−Wₑᵥ; according to some of the herein described embodiments.

In a first step 810, it is determined if the difference D is smaller than or equal to zero; D≤0; which would mean that the effective vehicle width Wₑᵥ is equal to or wider/larger than the usable road width Wᵤᵣ. If the difference D is smaller than or equal to zero; D≤0; the method 800 proceeds to a step 840, in which the adjusted reference speed v_{ref_adj} is determined 220 such that the vehicle 500 is prevented from entering into the road section 620 because entering would be dangerous, as herein described. If the difference D is larger than zero; D>0; the method proceeds to the second step 820.

In the second step 820, it is determined if the difference D is smaller than or equal to 20% of the usable road width Wᵤᵣ; D≤0.2*Wᵤᵣ; which would mean that the usable road width Wᵤᵣ is 20% or less wider than the effective vehicle width Wₑᵥ. If this is the case, the method 800 proceeds to the step 840, in which the adjusted reference speed v_{ref_adj} is determined 220 such that the vehicle 500 is prevented from entering into the road section 620. If the difference D is larger than 20% of the usable road width Wᵤᵣ, the method proceeds to the third step 830.

In the third step 830, it is determined if the difference D is larger than 20% of the usable road width Wᵤᵣ and smaller than 50% of the usable road width Wᵤᵣ; 0.2* Wᵤᵣ<D<0.5*Wᵤᵣ; which would mean that the usable road width Wᵤᵣ is more than 20% and less than 50% wider than the effective vehicle width Wₑᵥ. If this is the case, the method 800 proceeds to a step 850, in which the adjusted reference speed v_{ref_adj} is determined 220 such that the vehicle 500 is allowed to enter into the road section 620, but with reduced vehicle speed v. Thus, the adjusted reference speed v_{ref_adj} is determined 220 to be reduced below the reference speed v_{ref}, as herein described. If the difference D is equal to or larger than 50% of the of the usable road width Wᵤᵣ, the method proceeds to the first step 810 again, i.e. no adjusted reference speed v_{ref_adj} is determined, and the method 800 starts over again.

According to an embodiment, the speed control system 551 providing the reference speed v_{ref} is any suitable, possibly conventional, speed control system, such as for example a cruise control system of some kind, an adaptive cruise control system, an active prediction cruise control system, a curve speed cruise control system, a one pedal drive system, an adaptive one pedal drive system, a cruise control system obtaining a speed demand from an offboard entity and/or a cruise control system utilizing traffic sign recognition. The herein presented method may be combined with essentially any speed control system providing a reference speed v_{ref} towards which a vehicle speed should be controlled. The herein presented method then adjusts this provided reference speed v_{ref} such that a difference D between the usable road width Wᵤᵣ and the effective vehicle width Wₑᵥ is taken into consideration in the control 230 of the vehicle speed v in the road section 620.

According to an embodiment, the usable road width Wᵤᵣ is determined 221 based on information provided by one or more onboard sensors 581. Such onboard sensors 581 may comprise, or be comprised in, any suitable sensor or system providing an indication associated with the usable road width Wᵤᵣ, for example a camera, a radar system, a sonar system, a lidar system, a road sensor of some kind.

According to an embodiment, the usable road width Wᵤᵣ is determined 222 based on map data. Detailed map data may have information associated with obstacles, buildings and/or infrastructure entities on or adjacent to the road section 620. For example, rails, posts and/or pillars on the road section 620 decreases the usable road width Wᵤᵣ. Such information from the map data may be utilized for determining 222 the usable road width Wᵤᵣ for the road section 620, and may thus be used as basis for determining 220 the adjusted reference speed v_{ref_adj}.

According to an embodiment, the usable road width Wᵤᵣ in the road section 620 is determined 223 based on vehicle-to-everything (V2X) information. The vehicle-to-everything information may comprise information associated with usable road width Wᵤᵣ for the road section 620 having been performed by other vehicles. Other vehicles and/or other off board entities, e.g. entities comprising traffic information cameras, commonly denoted as 573 in FIG. 1, may also report if new obstacles have occurred in the road section 620 that affect the usable road width Wᵤᵣ, if there are roadwork/repairs that affect the usable road width Wᵤᵣ, or if there are accidents and/or vehicles at standstill in the road section 620. The vehicle-to-everything information may also comprise traffic information, information associated with traffic intensity, information associated with persons and/or bicycles in the road section 620, information associated with persons adjacent to the road section, e.g. children waiting on a school bus.

According to an embodiment, the usable road width Wᵤᵣ comprises a drivable road width W_{dr} of the road section 620 minus/except an unusable road width Wᵤᵤ of the road section 620; Wᵤᵣ=W_{dr}−Wᵤᵤ. The drivable road width W_{dr} is the width of the road from road edge to road edge, alternatively from a road edge to a central railing.

The unusable road width Wᵤᵤ may e.g. be occupied by at least one other oncoming vehicle 650 traveling in the road section 620 in a direction opposite to the vehicle 500 or a safety area around at least one such other oncoming vehicle 650. A safety area is in this document a sector/region around the other vehicle 650 exceeding the physical longitudinal and/or cross-sectional size of the other vehicle 650. The size of the safety area may depend on, i.e. may be determined based on, a speed difference between the vehicle 500 and the other vehicle 650, an accuracy of measurements/sensors, wind pushing other vehicles/bicycles 650 sideways, and/or a road area swept by the other vehicle 650 in a curve.

The unusable road width Wᵤᵤ may also be occupied by at least one other vehicle traveling in the road section 620 in a same direction as the vehicle 500 and at a different speed vₒ than the vehicle speed v of the vehicle 500; vₒ≠v; or a safety area around at least one such other vehicle.

The unusable road width Wᵤᵤ may also be occupied by at least one stationary/standstill vehicle on the road in the road section 620, at least one obstacle 630 on the road in the road section 620, at least one person on the road in the road section 620 and/or at least one object on the road in the road section 620. For example, rails, posts and/or pillars on the road section may increase the unusable road width Wᵤᵤ, and thus the decrease the usable road width Wᵤᵣ.

The unusable road width Wᵤᵤ may also be occupied by a safety zone around at least one stationary vehicle, at least one obstacle 630, at least one person and/or at least one object adjacent to the road in the road section 620. Thus, accident sensitive, and possibly moving offroad vehicles, objects and/or persons, which may cause insecurity/hesitance for a driver of the vehicle 500 may be taken into consideration by including the safety zone around them into the unusable road width Wᵤᵤ. The size of the safety zone depends on the situation and/or on the vehicles, objects and/or persons. For example, the safety zone may be wider/larger around playing children than around adults. The safety zone may also be wider/larger around a wobbly bicycle than around a car. The safety zone may also be wider/larger around a possibly opening passenger car door, than around a trailer. The safety zone may also be wider/larger around a movable/moving offroad object than around a more stationary/non-moving object.

According to an embodiment, the method 200 comprises a determination 224 of the effective vehicle width Wₑᵥ of the vehicle 500 for the road section 620 when it comprises at least one curve. The effective vehicle width Wₑᵥ is here based on a road area swept by the vehicle 500 in the at least one curve. The effective vehicle width Wₑᵥ of the vehicle 500 for the at least one curve then exceeds a physical width W_{phy} of the vehicle 500; Wₑᵥ>W_{phy}. The road area swept by the vehicle 500 in the at least one curve may be determined based on a physical width W_{phy} of the vehicle 500 and/or a geometry of the vehicle combination in curves. For example, a tractor and a semi-trailer sweep a larger area than a rigid truck and a trailer or full trailer sweep in a curve. Also, a steered rear axis reduces the swept area, and thus the effective vehicle width Wₑᵥ.

According to an embodiment, the method 200 comprises a determination 225 of the effective vehicle width Wₑᵥ of the vehicle 500 for at least one straight road stretch to be equal to a physical width W_{phy} of the vehicle 500; Wₑᵥ=W_{phy}.

According to an aspect, a control system 550 configured to control a vehicle speed v of a vehicle 500 is presented. the control system 550 is configured to control 230 the vehicle speed v towards an adjusted reference speed v_{ref_adj}, as herein described, i.e. based on a reference speed v_{ref} provided by a speed control system 550 of the vehicle 500, a usable road width Wᵤᵣ of a road section 620 ahead of the vehicle 500, and an effective vehicle width Wₑᵥ of the vehicle 500.

According to various embodiments, control system 550 is configured to determine 220 the adjusted reference speed v_{ref_adj} based also on further parameters, as herein described. The control system 550 is thus configured for performing the herein described method 200, i.e. to perform the herein described aspects and embodiments.

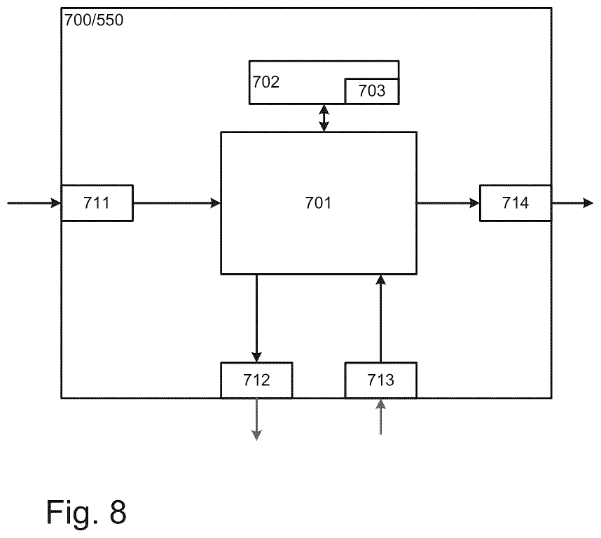

FIG. 8 shows in schematic representation a control unit 700/550. The control unit 700/550 comprises a computing unit 701, which can be constituted by essentially any suitable type of processor or microcomputer, for example a circuit for digital signal processing (Digital Signal Processor, DSP), or a circuit having a predetermined specific function (Application Specific Integrated Circuit, ASIC). The computing unit 701 is connected to a memory unit 702 arranged in the control unit 700/550, which memory unit provides the computing unit 701 with, for example, the stored program code and/or the stored data which the computing unit 701 requires to be able to perform computations. The computing unit 701 is also arranged to store partial or final results of computations in the memory unit 702.

In addition, the control unit 700/550 is provided with devices 711, 712, 713, 714 for receiving and transmitting input and output signals. These input and output signals can contain waveforms, impulses, or other attributes which, by the devices 711, 713 for the reception of input signals, can be detected as information and can be converted into signals which can be processed by the computing unit 701. These signals are then made available to the computing unit 701. The devices 712, 714 for the transmission of output signals are arranged to convert signals received from the computing unit 701 in order to create output signals by, for example, modulating the signals, which can be transmitted to other parts of and/or systems in the vehicle.

Each of the connections to the devices for receiving and transmitting input and output signals can be constituted by one or more of a cable; a data bus, such as a CAN bus (Controller Area Network bus), a MOST bus (Media Orientated Systems Transport bus), or some other bus configuration; an ethernet connection; or by a suitable wireless connection. A person skilled in the art will appreciate that the above-stated computer can be constituted by the computing unit 701 and that the above-stated memory can be constituted by the memory unit 702.

Control systems in modern vehicles commonly comprise communication bus systems consisting of one or more communication buses for linking a number of electronic control units (ECU's), or controllers, and various components located on the vehicle. Such a control system can comprise a large number of control units and the responsibility for a specific function can be divided amongst more than one control unit. Vehicles of the shown type thus often comprise significantly more control units than are shown in FIGS. 1 and 8, which is well known to the person skilled in the art within this technical field.

In a shown embodiment, the present invention may be implemented by the one or more herein mentioned control units or processing arrangements 700/550. The invention can also, however, be implemented wholly or partially in one or more other control units already present in the vehicle, or in some control unit dedicated to the present invention.

Here and in this document, control units, control entities or processing arrangements are sometimes described as being arranged for performing the methods and/or steps 210, 220, 230, 221, 222, 223, 224, 225 according to the invention. This also includes that the units, entities or processing arrangements are designed to and/or configured to perform these method steps.

One or more control entities 410, 420, 430, 421, 422, 423, 424, 425 may be arranged for performing the methods and/or steps. Such entities 410, 420, 430, 421, 422, 423, 424, 425 may be arranged as separate entities, or may be logically separated but physically implemented in the same unit, or may be both logically and physically arranged together. These control entities 410, 420, 430, 421, 422, 423, 424, 425 may for example correspond to groups of instructions, which can be in the form of programming code, that are input into, and are utilized by a processor/computing unit 701 when the entities are active and/or are utilized for performing its method steps, respectively.

The present invention is not limited to the above described embodiments. Instead, the present invention relates to, and encompasses all different embodiments being included within the scope of the independent claims.

1. A method of a control system for controlling a vehicle speed v of a vehicle, the method comprising:
controlling the vehicle speed v towards an adjusted reference speed v_{ref_adj} based on:
a reference speed v_{ref} provided by a speed control system of the vehicle;
a usable road width Wᵤᵣ of a road section ahead of the vehicle; and
an effective vehicle width Wₑᵥ of the vehicle.

2. The method as claimed in claim 1, the method further comprising:
receiving the reference speed v_{ref} from the speed control system; and
determining the adjusted reference speed v_{ref_adj} based on:
the received reference speed v_{ref};
the usable road width Wᵤᵣ of the road section ahead of the vehicle; and
the effective vehicle width Wₑᵥ of the vehicle.

3. The method as claimed in claim 1, further comprising determining the adjusted reference speed v_{ref_adj} such that the vehicle is prevented from entering into the road section when a difference D between the usable road width Wᵤᵣ and the effective vehicle width Wₑᵥ; D=Wᵤᵣ−Wₑᵥ; is less than a first difference threshold D_{th_1}; D<D_{th_1}.

4. The method as claimed in claim 3, wherein the first difference threshold D_{th_1} is one in the group of:
a value associated with one or more of a current vehicle speed v_{cur}, a visibility of the road section, and a risk for injuries in the road section;
a value less than or equal to 20% of the usable road width Wᵤᵣ; D_{th_1}≤0.2*Wᵤᵣ; and
a value less than or equal to zero; D_{th_1}≤0.

5. The method as claimed in claim 1, further comprising determining that the adjusted reference speed v_{ref_adj} is reduced below the reference speed v_{ref} if the vehicle will enter into the road section when a difference D between the usable road width Wᵤᵣ and the effective vehicle width Wₑᵥ; D=Wᵤᵣ−Wₑᵥ; is less than a second difference threshold D_{th_2}; D<D_{th_2}.

6. The method as claimed in claim 5, wherein the second difference threshold D_{th_2} is one in the group of:
a value associated with one or more of; a current vehicle speed v_{cur}, a visibility of the road section, and a risk for injuries in the road section; and
a value less than 50% of the usable road width Wᵤᵣ; D_{th_2}<0.5*Wᵤᵣ.

7. The method as claimed in claim 1, wherein the speed control system is one in the group of:
a cruise control system;
an adaptive cruise control system; and
an active prediction cruise control system;
a curve speed cruise control system;
a one pedal drive system;
an adaptive one pedal drive system;
a cruise control system obtaining a speed demand from an offboard entity; and
a cruise control system utilizing traffic sign recognition.

8. The method as claimed in claim 1, wherein the method comprises:
determining the usable road width Wᵤᵣ based on information provided by one or more onboard sensors of the vehicle.

9. The method as claimed in claim 8, wherein the one or more onboard sensors comprise at least one in the group of:
a camera;
a radar system;
a sonar system;
a lidar system; and
a road sensor.

10. The method as claimed in claim 1, wherein the method comprises:
determining the usable road width Wᵤᵣ based on map data.

11. The method as claimed in claim 1, wherein the method comprises:
determining the usable road width Wᵤᵣ based on vehicle-to-everything information provided to the control system.

12. The method as claimed in claim 1, wherein the usable road width Wᵤᵣ comprises a drivable road width W_{dr} of the road section minus an unusable road width Wᵤᵤ of the road section; Wᵤᵣ=W_{dr}−Wᵤᵤ.

13. The method as claimed in claim 12, wherein the unusable road width Wᵤᵤ is occupied by one or more in the group of:
at least one other oncoming vehicle traveling in the road section in a direction opposite to the vehicle;
a safety area around at least one other oncoming vehicle traveling in the road section in a direction opposite to the vehicle;
at least one other vehicle traveling in the road section in a same direction as the vehicle and at a different speed vₒ than the vehicle speed v of the vehicle; vₒ≠v;
a safety area around at least one other vehicle traveling in the road section in a same direction as the vehicle and at a different speed vₒ than the vehicle speed v of the vehicle vₒ≠v;
at least one stationary vehicle on the road in the road section;
at least one obstacle on the road in the road section;
at least one hole on the road in the road section;
at least one person on the road in the road section;
at least one object on the road in the road section;
a safety zone around at least one stationary vehicle adjacent to the road in the road section;
a safety zone around at least one obstacle adjacent to the road in the road section;
a safety zone around at least one person adjacent to the road in the road section; and
a safety zone around at least one object adjacent to the road in the road section.

14. The method as claimed in claim 1, wherein the road section comprises at least one curve, and the method comprises:
determining the effective vehicle width Wₑᵥ of the vehicle for the at least one curve based on a road area swept by the vehicle in the at least one curve, wherein the effective vehicle width Wₑᵥ of the vehicle for the at least one curve exceeds a physical width W_{phy} of the vehicle; Wₑᵥ>W_{phy}.

15. The method as claimed in claim 1, wherein the road section comprises at least one straight road stretch, and the method comprises:
determining the effective vehicle width Wₑᵥ of the vehicle for the at least one straight road stretch to be equal to a physical width W_{phy} of the vehicle Wₑᵥ=W_{phy}.

16. A computer program product stored on a non-transitory computer-readable medium, said computer program product used with a control system for controlling a vehicle speed v of the vehicle, wherein said computer program product comprising computer instructions to cause a computer to perform the following operations:
control the vehicle speed v towards an adjusted reference speed v_{ref_adj} based on:
a reference speed v_{ref} provided by a speed control system of the vehicle;
a usable road width Wᵤᵣ of a road section ahead of the vehicle; and
an effective vehicle width Wₑᵥ of the vehicle.

17. (canceled)

18. A control system configured to control a vehicle speed v of a vehicle wherein the control system is configured to:
control the vehicle speed v towards an adjusted reference speed v_{ref_adj} based on:
a reference speed v_{ref} provided by a speed control system of the vehicle;
a usable road width Wᵤᵣ of a road section ahead of the vehicle; and
an effective vehicle width Wₑᵥ of the vehicle.

19. A vehicle comprising a control system configured to control a vehicle speed v of the vehicle, wherein the control system is configured to:
control the vehicle speed v towards an adjusted reference speed v_{ref_adj} based on:
a reference speed v_{ref} provided by a speed control system of the vehicle;
a usable road width Wᵤᵣ of a road section ahead of the vehicle; and
an effective vehicle width Wₑᵥ of the vehicle.
